(19) United States
(12) Patent Application Publication
(10) Pub. No.: US 2021/0271048 A1
(43) Pub. Date: Sep. 2, 2021

(54) SECURING STRUCTURE FOR OPTICAL COMPONENT, OPTICAL UNIT, AND DEVICE

(71) Applicant: SONY CORPORATION, TOKYO (JP)

(72) Inventors: AKIHIRO MAESAKA, TOKYO (JP); TAKUMI OKITA, TOKYO (JP); YUKIKO MIZUGUCHI, TOKYO (JP)

(21) Appl. No.: 17/250,327

(22) PCT Filed: Jun. 7, 2019
(86) PCT No.: PCT/JP2019/022749

§ 371 Date: Jan. 5, 2021

(30) Foreign Application Priority Data
Jul. 13, 2018 (JP) 2018-133013

(51) Int. Cl. G02B 7/02

(52) U.S. Cl. CPC G02B 7/025

(57) ABSTRACT

Provided is a securing structure for an optical component enabling stress generated when adhesive for securing an optical component is cured and shrunk to be reduced and enabling distortion of the optical component to be suppressed. Provided is a securing structure for an optical component including an optical component, and an adhesive portion that is in contact with a holding portion for the optical component. The adhesive portion includes a first adhesive cured material layer and a second adhesive cured material layer, the first adhesive cured material layer is located between the optical component and the second adhesive cured material layer, and a storage elastic modulus of the first adhesive cured material layer is lower than a storage elastic modulus of the second adhesive cured material layer.

### TECHNICAL FIELD

The present technology relates to a securing structure for an optical component, an optical unit, and a device including the optical unit.

### BACKGROUND ART

There is a case where, in securing an optical component such as a lens to a securing frame by means of adhesive, curing and shrinkage of the adhesive cause distortion and displacement of the optical component. Various technologies for suppressing such distortion and displacement of the optical component have been proposed. For example, Patent Document 1 describes a securing structure for an optical member in which high-elasticity adhesive is used to position and secure an optical member to a holding means, and in which low-elasticity adhesive is used to fill a gap between the holding means and the optical member. Also, Patent Document 2 describes a lens assembly including an adhesive auxiliary member including an elastic member that can be deformed by a force applied from adhesive when the adhesive is cured.

### CITATION LIST

### Patent Document

Patent Document 1: Japanese Patent Application Laid-Open No. 2004-133073
Patent Document 2: Japanese Patent Application Laid-Open No. 2016-85311

### SUMMARY OF THE INVENTION

### Problems to be Solved by the Invention

In the case of the technology described in Patent Document 1, when the high-elasticity adhesive is cured, there is a possibility that high stress is generated at the interface between the high-elasticity adhesive and the optical member, and that locally large distortion is generated in the optical member. In the case of the technology described in Patent Document 2, it is difficult to reduce the stress caused by curing and shrinkage generated at the interface between the adhesive and the lens, and there is a possibility that distortion is generated in the lens.

Therefore, a main object of the present technology is to provide a securing structure for an optical component enabling stress generated when adhesive for securing an optical component is cured and shrunk to be reduced and enabling distortion of the optical component to be suppressed.

### Solutions to Problems

The present inventor has noticed that the conventional technologies represented by Patent Document 1 and Patent Document 2 described above can contribute to reduction of internal stress in an entire optical component but have difficulty in reduction of stress generated at the interface between the optical component and adhesive and has intensively studied a technology enabling the stress at the interface to be reduced. As a result, the present inventor has arrived at the present technology upon discovering that, by providing an adhesive cured material layer having a specific storage elastic modulus in a securing structure for an optical component, the stress generated at the interface between the optical component and the adhesive can be reduced, and distortion of the optical component can be suppressed.

That is, the present technology provides a securing structure for an optical component, including an optical component, and an adhesive portion that is in contact with a holding portion for the optical component,

in which the adhesive portion includes a first adhesive cured material layer and a second adhesive cured material layer,

the first adhesive cured material layer is located between the optical component and the second adhesive cured material layer, and

a storage elastic modulus of the first adhesive cured material layer is lower than a storage elastic modulus of the second adhesive cured material layer.

The storage elastic modulus of the first adhesive cured material layer may be ½ or less of the storage elastic modulus of the second adhesive cured material layer.

The storage elastic modulus of the second adhesive cured material layer may be 10 MPa or more in a dynamic mechanical analysis under conditions of 1 Hz and 30° C.

The first adhesive cured material layer may contain a cured material of silicone adhesive, a cured material of modified silicone adhesive, or a cured material of urethane adhesive.

The securing structure for an optical component may further include

a third adhesive cured material layer,

in which the third adhesive cured material layer may be arranged at a position opposed to the first adhesive cured material layer with the second adhesive cured material layer interposed therebetween, and

a storage elastic modulus of the third adhesive cured material layer may be lower than the storage elastic modulus of the second adhesive cured material layer.

Also, the present technology provides an optical unit including the securing structure for an optical component, and the holding portion that holds the optical component.

Also, the present technology provides a device including the optical unit.

Also, the present technology provides an optical unit including the securing structure for an optical component, and a metallic holding portion that holds the optical component,

in which the optical component is a glass lens,

in a case where a diameter of the glass lens is 25 mm or more, each of a width and a height of the adhesive portion is 1/10 or less of the diameter of the glass lens, and

in a case where the diameter of the glass lens is less than 25 mm, each of the width and the height of the adhesive portion is 2.5 mm or less.

In the optical unit, a thickness of the first adhesive cured material layer may be 0.2 mm or more.

In the optical unit,

the glass lens may have a Young's modulus of 50 GPa or more and a thickness of 5 mm or more,

the storage elastic modulus of the first adhesive cured material layer may be ¼ or less of the storage elastic modulus of the second adhesive cured material layer, and

the storage elastic modulus of the second adhesive cured material layer may be 21 MPa or less in the dynamic mechanical analysis under conditions of 1 Hz and 30° C.

### Effects of the Invention

According to the present technology, in a technology for securing an optical component by means of adhesive, stress caused by curing and shrinkage of the adhesive can be reduced, and distortion of the optical component can be suppressed. Note that the effects of the present technology are not limited to those described herein but may be any effects described in the present description.

### BRIEF DESCRIPTION OF DRAWINGS

FIG. 1 is a schematic plan view illustrating an example of a securing structure 1 for an optical component according to a first embodiment.

FIG. 2 is an end view along the cross-sectional portion A-A in FIG. 1.

FIG. 3 is an end view along the cross-sectional portion A′-A′ in FIG. 1.

FIG. 4 is a schematic process explanatory diagram illustrating an example of a method for securing an optical component.

FIG. 5 is a schematic plan view illustrating an example of a securing structure 11 for an optical component according to a second embodiment.

FIG. 6 is an end view along the cross-sectional portion B-B in FIG. 5.

FIG. 7 is an end view along the cross-sectional portion B′-B′ in FIG. 5.

FIG. 8 is a schematic end view illustrating an example of a securing structure 21 for an optical component according to a third embodiment.

FIG. 9 is a schematic end view illustrating an example of a securing structure 31 for an optical component according to a fourth embodiment.

FIG. 10 provides schematic views illustrating cross-sections of optical units in Examples 1 to 3 and Comparative Examples 1 and 2.

FIG. 11 is a schematic view illustrating a cross-section of the optical unit in Example 4.

FIG. 12 provides graphs each illustrating the result of a viscoelasticity simulation using the optical unit in Example 4.

FIG. 13 is a graph illustrating the result of a viscoelasticity simulation using the optical unit in Example 4.

### MODE FOR CARRYING OUT THE INVENTION

Hereinbelow, a preferred mode for carrying out the present technology will be described with reference to the drawings. Note that the embodiments described below are representative embodiments of the present technology, and the scope of the present technology shall not be construed narrowly by these embodiments.

### First Embodiment

A securing structure for an optical component according to a first embodiment of the present technology will be described.

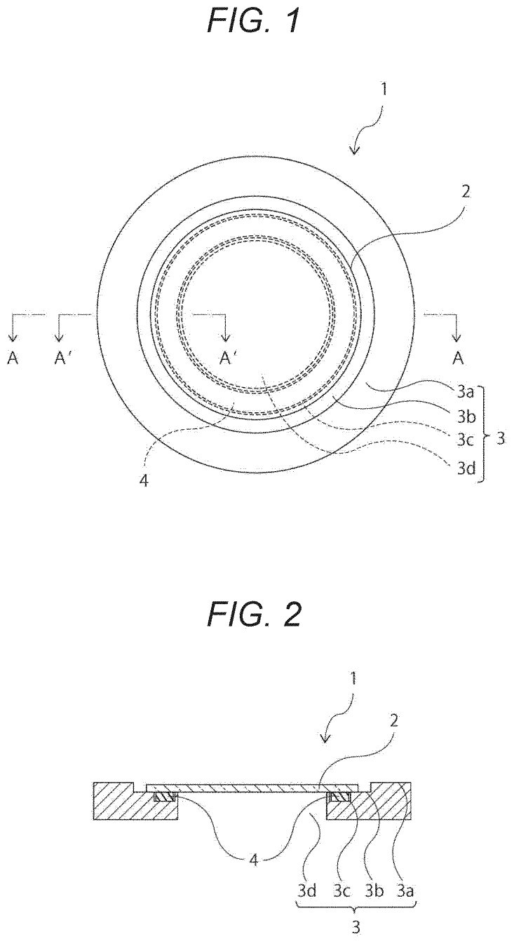

FIG. 1 is a schematic plan view illustrating an example of a securing structure 1 for an optical component according to the first embodiment. FIG. 2 is an end view along the cross-sectional portion A-A in FIG. 1. The securing structure 1 for an optical component includes an optical component 2 and an adhesive portion 4 in contact with a holding portion 3 for the optical component 2.

Examples of the optical component 2 include a lens and a polarizing plate. The shape of the optical component 2 is not particularly limited. In the present embodiment, a case where the optical component 2 is a circular plate-like lens will be described as an example. The material for the optical component 2 is not particularly limited, and examples thereof include glass, synthetic resin, synthetic quartz, and fluorite.

The shape of the holding portion 3 is not particularly limited. In the present embodiment, a case where the holding portion 3 is formed in a circular flat-plate shape and includes a holding frame 3a, a bottom surface portion 3b on which the optical component 2 is mounted, an adhesive groove 3c in which the adhesive portion 4 is housed, and a through hole 3d will be described as an example. The holding frame 3a is formed in an annular shape and is located on the outermost side of the holding portion 3. Inside the holding frame 3a is the bottom surface portion 3b. The bottom surface portion 3b is provided with the annular adhesive groove 3c. The through hole 3d is formed inside the adhesive groove 3c, that is, at the center portion of the bottom surface portion 3b.

As illustrated in FIG. 2, the optical component 2 is mounted on the bottom surface portion 3b to cover the adhesive groove 3c, and the lower surface of the optical component 2 is in contact with the bottom surface portion 3b. The adhesive portion 4 is provided inside the adhesive groove 3c. The upper surface of the adhesive portion 4 is in contact with the lower surface of the optical component 2, and the lower surface of the adhesive portion 4 is in contact with the bottom surface of the adhesive groove 3c.

The material forming the holding portion 3 is not particularly limited, and a material known in the art such as synthetic resin and metal can be used, for example. The method for forming the holding portion 3 is not particularly limited, and the holding portion 3 can be formed by a method known in the art such as cutting and injection molding.

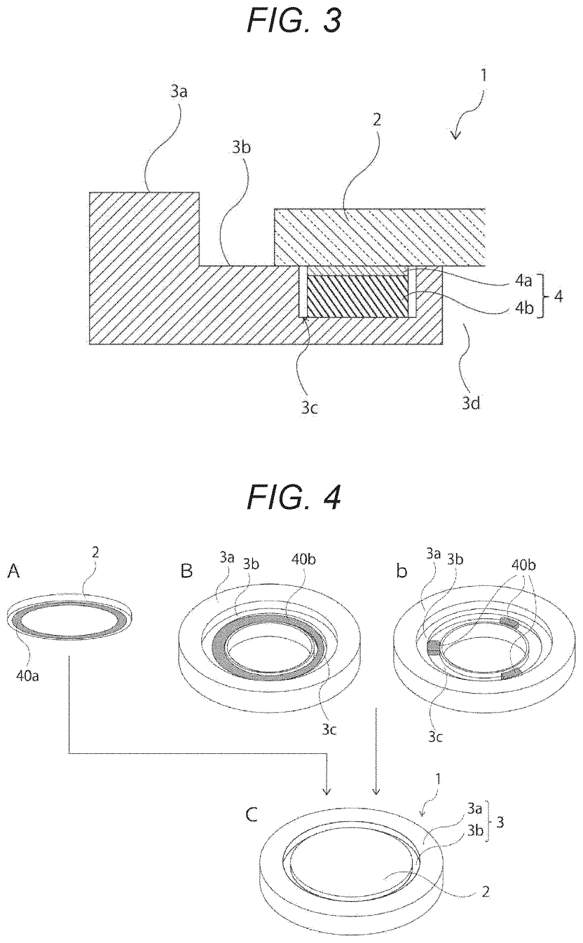

FIG. 3 is an end view along the cross-sectional portion A′-A′ in FIG. 1. As illustrated in FIG. 3, the adhesive portion 4 includes a first adhesive cured material layer 4a and a second adhesive cured material layer 4b. The first adhesive cured material layer 4a is located between the optical component 2 and the second adhesive cured material layer 4b. The second adhesive cured material layer 4b is located between the first adhesive cured material layer 4a and the holding portion 3 (the bottom surface of the adhesive groove 3c). The first adhesive cured material layer 4a is laminated on the second adhesive cured material layer 4b. The upper surface of the first adhesive cured material layer 4a is in contact with the lower surface of the optical component 2, and the lower surface of the second adhesive cured material layer 4b is in contact with the bottom surface of the adhesive groove 3c. With such a configuration, the adhesive portion 4 bonds and secures the optical component 2 and the holding portion 3 to each other.

Note that, in the present technology, the “adhesive cured material layer” means a layer including a cured material of adhesive. That is, the first adhesive cured material layer 4a and the second adhesive cured material layer 4b according to the present embodiment include cured adhesive.

In a process for curing adhesive, the volume of the adhesive is decreased as a bonding reaction and a cross-linking reaction of monomers and oligomers are progressed. At the adhesion interface, the adhesive is bonded to the optical component when the adhesive is in a liquid state, and when the volume of the adhesive decreases, the optical component cannot be shrunk together, stress caused by curing and shrinkage is generated at the interface between the adhesive and the optical component, and distortion is generated in the optical component.

In the securing structure 1 for an optical component according to the present embodiment, in order to prevent distortion from being generated in the optical component 2 by stress caused by curing and shrinkage of the adhesive, the storage elastic modulus of the first adhesive cured material layer 4a is set to be lower than the storage elastic modulus of the second adhesive cured material layer 4b. Preferably, the storage elastic modulus of the first adhesive cured material layer 4a is set to be ½ or less of the storage elastic modulus of the second adhesive cured material layer 4b.

Here, the storage elastic modulus will be described.

In general, adhesive used in the art contains a polymer material as a main component. A cured material of the adhesive containing a polymer material as a main component is a viscoelastic body having both elastic and viscous characteristics. Dynamic Mechanical Analysis (DMA) is known as a method for evaluating the viscoelasticity of a viscoelastic body. In the dynamic mechanical analysis, stress that fluctuates periodically is applied to a viscoelastic body, and the amplitude of distortion is measured, to derive the complex elastic modulus at each frequency. The complex elastic modulus represented by a complex number can be decomposed into two terms, the storage elastic modulus serving as a real part and the loss elastic modulus serving as an imaginary part. The storage elastic modulus is a term derived from elasticity, and the term, storage, means an effect in which a viscoelastic body stores elastic energy therein.

The storage elastic modulus in the present technology is obtained by the dynamic mechanical analysis under the conditions of a frequency of 1 Hz and a temperature of 30° C. The storage elastic modulus in the present technology is a value measured using a device in which a dynamic mechanical analysis (DMA) option (nanoDMAIII) is added to a nanoindentation device (Triboindenter TI980) manufactured by Hysitron.

Returning to FIG. 3, the present embodiment will further be described. The securing structure 1 for an optical component according to the present embodiment has a characteristic in which the first adhesive cured material layer 4a in contact with the optical component 2 has a lower storage elastic modulus than that of the second adhesive cured material layer 4b in contact with the adhesive groove 3c. In this manner, by providing the first adhesive cured material layer 4a having a relatively low storage elastic modulus between the optical component 2 and the second adhesive cured material layer 4b, the stress generated at the interface between the optical component 2 and the adhesive when the adhesive is cured and shrunk can be relaxed, and the distortion applied to the optical component 2 can be reduced.

The storage elastic modulus of the first adhesive cured material layer 4a is preferably ½ or less of the storage elastic modulus of the second adhesive cured material layer 4b. As a result, the distortion of the optical component 2 can be suppressed more effectively.

The storage elastic modulus of the first adhesive cured material layer 4a is preferably 5 MPa or less, more preferably 4 MPa or less, still more preferably 3 MPa or less, and particularly preferably 2.5 MPa or less in the dynamic mechanical analysis under the conditions of 1 Hz and 30° C. As a result, it is possible to exert a more excellent stress relaxation effect at the interface between the optical component 2 and the adhesive portion 4 and to suppress the distortion of the optical component 2 more effectively.

In the securing structure 1 for an optical component according to the present embodiment, stress is relaxed by one adhesive cured material layer (the first adhesive cured material layer 4a), and in the third embodiment and the fourth embodiment described below, stress is relaxed by two adhesive cured material layers (the first adhesive cured material layer and a third adhesive cured material layer). In a case where the storage elastic modulus is equal, the amount of distortion of the optical component in a case where two adhesive cured material layers that relax stress are provided is ½ of that in a case where one layer is provided according to the calculation. That is, in a case where the storage elastic modulus of the first adhesive cured material layer 4a according to the present embodiment is 2.5 MPa (½ of 5 MPa), a similar effect can be obtained to that in a case where stress is relaxed by two adhesive cured material layers each having the storage elastic modulus of 5 MPa. In this manner, by setting the storage elastic modulus of the first adhesive cured material layer 4a to 2.5 MPa or less, a high stress relaxation effect can be obtained with a simpler configuration.

The storage elastic modulus of the second adhesive cured material layer 4b is preferably 10 MPa or more, more preferably 15 MPa or more, and still more preferably 20 MPa or more in the dynamic mechanical analysis under the conditions of 1 Hz and 30° C. As a result, it is possible to further improve the adhesive strength.

The adhesive used for the first adhesive cured material layer 4a may be the same as or different from the adhesive used for the second adhesive cured material layer 4b. In a case where the adhesive used for the first adhesive cured material layer 4a and the adhesive used for the second adhesive cured material layer 4b are the same, the degree of curing of the first adhesive cured material layer 4a is set to be different from that of the second adhesive cured material layer 4b to make the storage elastic modulus of the first adhesive cured material layer 4a lower than that of the second adhesive cured material layer 4b.

The first adhesive cured material layer 4a preferably contains a cured material of silicone adhesive, a cured material of modified silicone adhesive, or a cured material of urethane adhesive to further improve the stress relaxation effect. The second adhesive cured material layer 4b preferably contains a cured material of modified acrylate adhesive. Since the modified acrylate adhesive is cured as in a short period as about several seconds by irradiation with UV light, the second adhesive cured material layer 4b can efficiently be formed by using the modified acrylate adhesive.

Next, a method for securing an optical component in the securing structure 1 for an optical component according to the present embodiment will be described.

FIG. 4 is a schematic process explanatory diagram illustrating an example of a method for securing an optical component. FIG. 4A is a schematic view illustrating a process for applying first adhesive 40a to the optical component 2. FIGS. 4B and 4b are schematic views each illustrating a process for applying second adhesive 40b to the adhesive groove 3c of the holding portion 3. FIG. 4C is a schematic view illustrating a process for mounting the optical component 2 on the bottom surface portion 3b in the holding portion 3.

First, as illustrated in FIG. 4A, the first adhesive 40a is applied to the lower surface of the optical component 2, that is, the surface of the optical component 2 in contact with the holding portion 3. The first adhesive 40a is adhesive that becomes the first adhesive cured material layer 4a when cured. The first adhesive 40a is applied to a position corresponding to the adhesive groove 3c of the holding portion 3. The application amount of the first adhesive 40a is preferably entirely uniform but may be slightly non-uniform as long as the effect of the present technology is not impaired. After the first adhesive 40a is applied, the first adhesive 40a is cured to form the first adhesive cured material layer 4a. The curing means is only required to be appropriately selected in accordance with the type of the first adhesive 40a.

Subsequently, as illustrated in FIG. 4B or FIG. 4b, the second adhesive 40b is applied to the inside of the adhesive groove 3c of the holding portion 3. The second adhesive 40b is adhesive that becomes the second adhesive cured material layer 4b when cured. The second adhesive 40b may be applied to the entire bottom surface of the adhesive groove 3c as illustrated in FIG. 4B or may be applied so as to be dotted inside the adhesive groove 3c as illustrated in FIG. 4b. Also, the application amount of the second adhesive 40b is preferably uniform but may be slightly non-uniform as long as the effect of the present technology is not impaired. Note that, as for the order, either the process for applying the first adhesive 40a to the optical component 2 or the process for applying the second adhesive 40b to the holding portion 3 may be first, or the processes may be at the same time.

Subsequently, as illustrated in FIG. 4C, the optical component 2 is mounted on the bottom surface portion 3b in the holding portion 3. At this time, the optical component 2 is mounted so that the first adhesive 40a applied to the lower surface of the optical component 2 and the second adhesive 40b applied to the adhesive groove 3c of the holding portion 3 are in contact with each other. Thereafter, the position of the optical component 2 with respect to the holding portion 3 is adjusted, and the second adhesive 40b is cured, to form the second adhesive cured material layer 4b. The curing means is only required to be appropriately selected in accordance with the type of the second adhesive 40b.

Note that the degree of curing may be adjusted by stopping curing of the first adhesive 40a in the middle so as for the first adhesive 40a not to be completely cured so that the first adhesive 40a is completely cured at the same time as the second adhesive 40b is cured.

With the above procedure, the adhesive portion 4 including the first adhesive cured material layer 4a and the second adhesive cured material layer 4b is formed, and the optical component 2 and the holding portion 3 are bonded and secured.

With the securing structure 1 for an optical component according to the present embodiment, stress generated in the optical component 2 when the adhesive is cured and shrunk can be reduced by the first adhesive cured material layer 4a, and distortion of the optical component 2 can be suppressed.

Also, in the securing structure 1 for an optical component according to the present embodiment, the holding portion 3 includes the adhesive groove 3c that houses the adhesive portion (the first adhesive cured material layer 4a and the second adhesive cured material layer 4b), and the lower surface of the optical component 2 is in contact with the bottom surface portion 3b of the holding portion 3. Since downward stress is generated in the optical component 2 when the second adhesive 40b is cured and shrunk, displacement of the optical component 2 is about to occur to relax the stress caused by the curing and shrinkage. However, with the securing structure 1 for an optical component according to the present embodiment, since the first adhesive cured material layer 4a relaxes stress, and the optical component 2 is secured at the bottom surface portion 3b, which is the contact surface with the holding portion 3, displacement of the optical component 2 is significantly suppressed. Therefore, the securing structure 1 for an optical component according to the present embodiment can effectively suppress displacement of the optical component 2.

### Second Embodiment

A securing structure for an optical component according to a second embodiment of the present technology will be described.

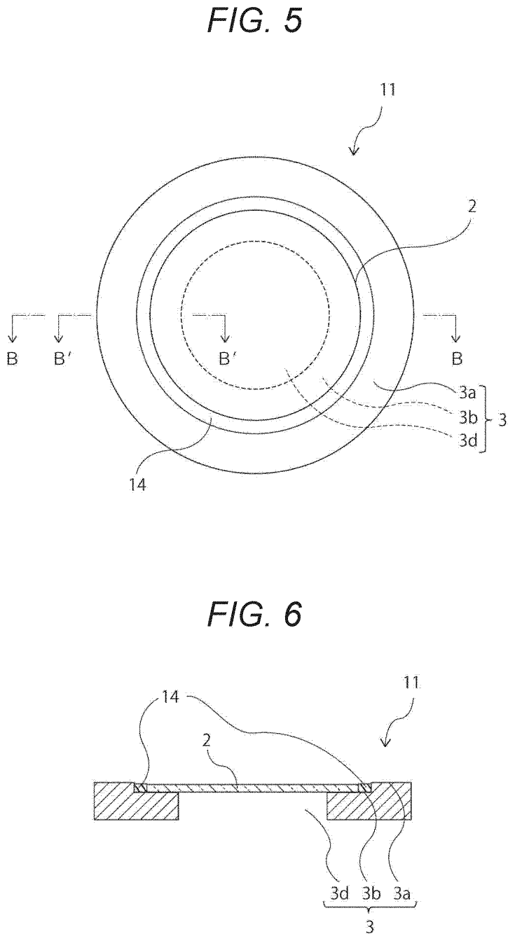

FIG. 5 is a schematic plan view illustrating an example of a securing structure 11 for an optical component according to the second embodiment. FIG. 6 is an end view along the cross-sectional portion B-B in FIG. 5. As illustrated in FIGS. 5 and 6, the securing structure 11 for an optical component according to the present embodiment includes an adhesive portion 14 instead of the adhesive portion 4 in the above first embodiment. On the other hand, the holding portion 3 described in the present embodiment does not include the adhesive groove 3c. The adhesive portion 14 is in contact with the outer peripheral surface of the optical component 2, the inner peripheral surface of the holding frame 3a, and the bottom surface portion 3b. Hereinbelow, different points from the above first embodiment will mainly be described.

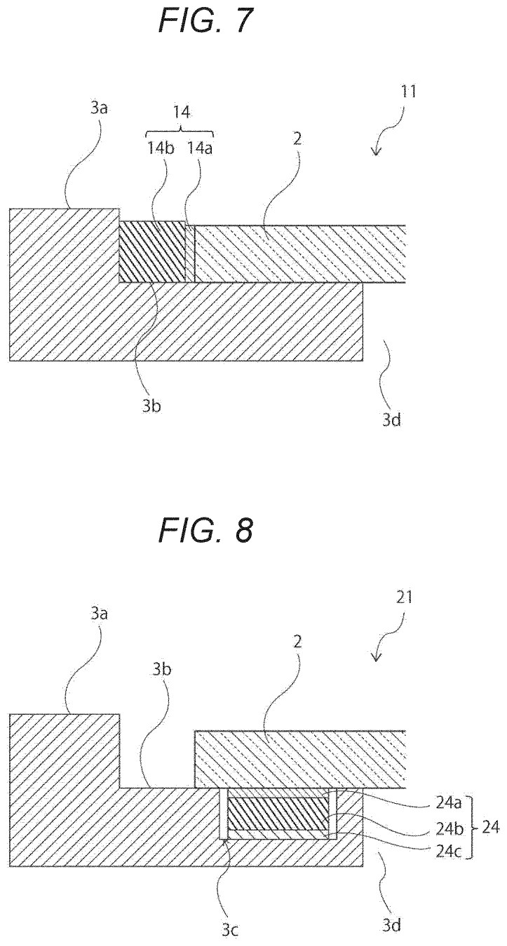

FIG. 7 is an end view along the cross-sectional portion B′-B′ in FIG. 5. As illustrated in FIG. 7, the adhesive portion 14 includes a first adhesive cured material layer 14a and a second adhesive cured material layer 14b. The first adhesive cured material layer 14a is located between the optical component 2 and the second adhesive cured material layer 14b. The second adhesive cured material layer 14b is located between the first adhesive cured material layer 14a and the holding portion 3 (the holding frame 3a). More specifically, the first adhesive cured material layer 14a is in contact with the outer peripheral surface of the optical component 2, the second adhesive cured material layer 14b, and the bottom surface portion 3b. The second adhesive cured material layer 14b is in contact with the first adhesive cured material layer 14a, the inner peripheral surface of the holding frame 3a, and the bottom surface portion 3b. With such a configuration, the adhesive portion 14b bonds and secures the optical component 2 and the holding portion 3 to each other.

With the securing structure 11 for an optical component according to the present embodiment, stress generated in the optical component 2 when the adhesive is cured and shrunk can be reduced by the first adhesive cured material layer 14a, and distortion of the optical component 2 can be suppressed.

Displacement of the optical component 2 is about to occur to relax the stress caused by the curing and shrinkage of the adhesive. However, with the securing structure 11 for an optical component according to the present embodiment, since the first adhesive cured material layer 14a relaxes the stress generated in the optical component 2, the displacement of the optical component 2 can be suppressed.

### Third Embodiment

A securing structure for an optical component according to a third embodiment of the present technology will be described.

FIG. 8 is a schematic end view illustrating an example of a securing structure 21 for an optical component according to the third embodiment. The securing structure 21 for an optical component according to the present embodiment includes an adhesive portion 24 instead of the adhesive portion 4 in the above first embodiment. The adhesive portion 24 includes a third adhesive cured material layer 24c in addition to a first adhesive cured material layer 24a and a second adhesive cured material layer 24b. Hereinbelow, different points from the above first embodiment will mainly be described.

As illustrated in FIG. 8, the adhesive portion 24 includes the first adhesive cured material layer 24a, the second adhesive cured material layer 24b, and the third adhesive cured material layer 24c. The third adhesive cured material layer 24c is arranged at a position opposed to the first adhesive cured material layer 24a with the second adhesive cured material layer 24b interposed therebetween.

More specifically, the first adhesive cured material layer 24a is located between the optical component 2 and the second adhesive cured material layer 24b. The second adhesive cured material layer 24b is located between the first adhesive cured material layer 24a and the third adhesive cured material layer 24c. The third adhesive cured material layer 24c is located between the second adhesive cured material layer 24b and the holding portion 3 (the bottom surface of the adhesive groove 3c). That is, the first adhesive cured material layer 24a is laminated on the second adhesive cured material layer 24b, and the second adhesive cured material layer 24b is laminated on the third adhesive cured material layer 24c. The upper surface of the first adhesive cured material layer 24a is in contact with the lower surface of the optical component 2, and the lower surface of the third adhesive cured material layer 24c is in contact with the bottom surface of the adhesive groove 3c. With such a configuration, the adhesive portion 24 bonds and secures the optical component 2 and the holding portion 3 to each other.

The storage elastic modulus of the third adhesive cured material layer 24c is preferably lower than the storage elastic modulus of the second adhesive cured material layer 24b and is more preferably ½ or less of the storage elastic modulus of the second adhesive cured material layer 24b. As a result, the distortion of the optical component 2 can be suppressed more effectively. The storage elastic modulus of the third adhesive cured material layer 24c is preferably 5 MPa or less, more preferably 4 MPa or less, still more preferably 3 MPa or less, and particularly preferably 2.5 MPa or less in the dynamic mechanical analysis under the conditions of 1 Hz and 30° C. As a result, the stress caused by curing and shrinkage of the adhesive can be relaxed more effectively, and the distortion of the optical component 2 can further be suppressed. The storage elastic modulus of the third adhesive cured material layer 24c may be the same as or different from the storage elastic modulus of the first adhesive cured material layer 24a.

The adhesive used for the third adhesive cured material layer 24c may be the same as or different from the adhesive used for the first adhesive cured material layer 24a. Also, the adhesive used for the third adhesive cured material layer 24c may be the same as or different from that for the second adhesive cured material layer 24b. The adhesives used for the first adhesive cured material layer 24a, the second adhesive cured material layer 24b, and the third adhesive cured material layer 24c may all be the same. In a case where the adhesive used for the second adhesive cured material layer 24b and the adhesive used for the third adhesive cured material layer 24c are the same, the degree of curing of the second adhesive cured material layer 24b is preferably set to be different from that of the third adhesive cured material layer 24c. Therefore, the storage elastic modulus of the third adhesive cured material layer 24c is preferably lower than that of the second adhesive cured material layer 24b.

The third adhesive cured material layer 24c preferably contains a cured material of silicone adhesive, a cured material of modified silicone adhesive, or a cured material of urethane adhesive to further improve the stress relaxation effect.

With the securing structure 21 for an optical component according to the present embodiment, stress generated in the optical component 2 when the adhesive is cured and shrunk can be reduced by the first adhesive cured material layer 24a and the third adhesive cured material layer 24c, and distortion of the optical component 2 can be suppressed. Since the securing structure 21 for an optical component according to the present embodiment includes the third adhesive cured material layer 24c, the securing structure 21 for an optical component exerts a higher stress relaxation effect than the securing structure 1 for an optical component according to the above first embodiment, and the distortion of the optical component 2 can be suppressed more effectively.

Also, in the securing structure 21 for an optical component according to the present embodiment, since the optical component 2 is secured at the bottom surface portion 3b of the holding portion 3 as in the above first embodiment, displacement of the optical component 2 can be suppressed effectively.

### Fourth Embodiment

A securing structure for an optical component according to a fourth embodiment of the present technology will be described.

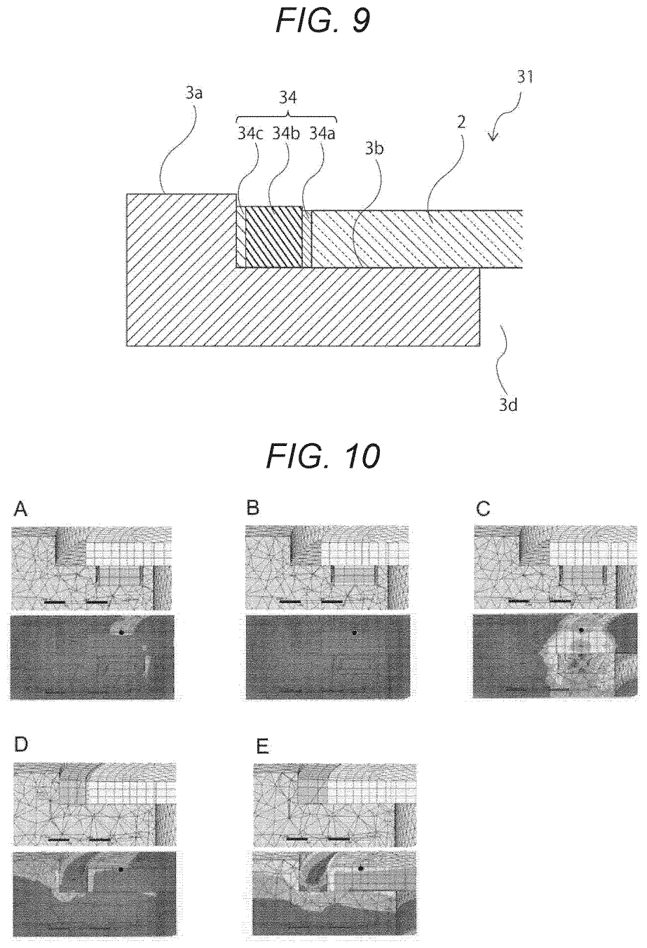

FIG. 9 is a schematic end view illustrating an example of a securing structure 31 for an optical component according to the fourth embodiment. As illustrated in FIG. 9, the securing structure 31 for an optical component according to the present embodiment includes an adhesive portion 34 instead of the adhesive portion 14 in the above second embodiment. The adhesive portion 34 includes a third adhesive cured material layer 34c in addition to a first adhesive cured material layer 34a and a second adhesive cured material layer 34b. The adhesive portion 34 is in contact with the outer peripheral surface of the optical component 2, the inner peripheral surface of the holding frame 3a, and the bottom surface portion 3b. Hereinbelow, different points from the above second embodiment will mainly be described.

As illustrated in FIG. 9, the adhesive portion 34 includes the first adhesive cured material layer 34a, the second adhesive cured material layer 34b, and the third adhesive cured material layer 34c. The third adhesive cured material layer 34c is arranged at a position opposed to the first adhesive cured material layer 34a with the second adhesive cured material layer 34b interposed therebetween.

More specifically, the first adhesive cured material layer 34a is located between the optical component 2 and the second adhesive cured material layer 34b. The second adhesive cured material layer 34b is located between the first adhesive cured material layer 34a and the third adhesive cured material layer 34c. The third adhesive cured material layer 34c is located between the second adhesive cured material layer 34b and the holding portion 3 (the holding frame 3a). More specifically, the first adhesive cured material layer 34a is in contact with the outer peripheral surface of the optical component 2, the second adhesive cured material layer 34b, and the bottom surface portion 3b. The second adhesive cured material layer 34b is in contact with the first adhesive cured material layer 34a, the third adhesive cured material layer 34c, and the bottom surface portion 3b. The third adhesive cured material layer 34c is in contact with the second adhesive cured material layer 34b, the inner peripheral surface of the holding frame 3a, and the bottom surface portion 3b. With such a configuration, the adhesive portion 34 bonds and secures the optical component 2 and the holding portion 3 to each other.

Since the preferred embodiment of the third adhesive cured material layer 34c is the same as that of the third adhesive cured material layer 24c in the above third embodiment, the description thereof is omitted here.

With the securing structure 31 for an optical component according to the present embodiment, stress generated in the optical component 2 when the adhesive is cured and shrunk can be reduced by the first adhesive cured material layer 34a and the third adhesive cured material layer 34c, and distortion of the optical component 2 can be suppressed. Since the securing structure 31 for an optical component according to the present embodiment includes the third adhesive cured material layer 34c, the securing structure 31 for an optical component exerts a higher stress relaxation effect than the securing structure 11 for an optical component according to the above second embodiment, and the distortion of the optical component 2 can be suppressed more effectively.

### Fifth Embodiment

An optical unit according to a fifth embodiment of the present technology will be described.

The optical unit according to the present embodiment includes the above securing structure for an optical component that includes the optical component and the adhesive portion and the holding portion that holds the optical component. That is, the optical unit according to the present embodiment includes an optical component, a holding portion that holds the optical component, and an adhesive portion in contact with the holding portion. The optical unit according to the present embodiment can be a lens unit or a polarizing plate unit, for example.

Configurations of the securing structure for an optical component and the holding portion in the optical unit according to the present embodiment can be the configurations described in each of the above first to fourth embodiments.

The optical unit according to the present embodiment that includes the above securing structure for an optical component exhibits favorable optical performance since the distortion of the optical component is suppressed.

### Sixth Embodiment

An optical unit according to a sixth embodiment of the present technology will be described.

The optical unit according to the present embodiment includes the securing structure for an optical component according to the first embodiment and a metallic holding portion that holds an optical component, and the optical component is a glass lens. The optical unit according to the present embodiment will be described with reference to FIG. 3, which illustrates the first embodiment.

In the optical unit according to the present embodiment, in a case where the diameter of a glass lens 2 is 25 mm or more, each of the width and the height of the adhesive portion 4 that bonds and secures the glass lens 2 and the holding portion 3 to each other is preferably 1/10 or less of the diameter of the glass lens 2. By decreasing the ratio of the adhesive region of the adhesive portion 4 to the area of the glass lens 2, the practicality of the optical unit can be enhanced. On the other hand, in a case where the diameter of the glass lens 2 is less than 25 mm, each of the width and the height of the adhesive portion 4 is preferably 2.5 mm or less in consideration of the space required for using the adhesive. Note that the width of the adhesive portion 4 means a length along the width direction of the adhesive groove 3c. Also, the height of the adhesive portion 4 is a distance between the lower surface of the glass lens 2 and the bottom surface of the adhesive groove 3c and is equal to the sum of the thickness of the first adhesive cured material layer 4a and the thickness of the second adhesive cured material layer 4b.

The thickness of the first adhesive cured material layer 4a in the optical unit according to the present embodiment is preferably 0.2 mm or more to secure the film thickness required for relaxing the distortion energy due to curing and shrinkage of the second adhesive cured material layer 4b. In a case where the thickness of the first adhesive cured material layer 4a is 0.2 mm or more, a substantially constant distortion suppressing effect can be obtained even in a case where the thickness slightly fluctuates and varies.

In the optical unit according to the present embodiment, it was confirmed by a test that the stress relaxation effect became larger as the storage elastic modulus of the first adhesive cured material layer 4a was smaller, and that the distortion of the surface of the glass lens 2 could be reduced. That is, in order to suppress the distortion of the surface of the glass lens 2 caused by curing and shrinkage of the adhesive, it is preferable to lower the storage elastic modulus of the first adhesive cured material layer 4a.

Here, since the performance of a glass lens depends on the distortion of the surface, a glass lens having high flatness with surface unevenness (deformation amount) of 0.01 μm or less is required for a high-performance lens in some cases. In order to suppress the distortion of the surface of the glass lens 2 and reduce the unevenness in a case where the thickness of the first adhesive cured material layer 4a is 0.2 mm or more, it is preferable to lower the storage elastic modulus of the first adhesive cured material layer 4a as described above. In addition, in order to achieve higher flatness, it is preferable to adjust the storage elastic modulus of the second adhesive cured material layer 4b and the Young's modulus and thickness of the glass lens 2.

Specifically, the storage elastic modulus of the first adhesive cured material layer 4a is preferably ¼ or less of the storage elastic modulus of the second adhesive cured material layer 4b. The storage elastic modulus of the second adhesive cured material layer 4b is preferably 21 MPa or less in the dynamic mechanical analysis under the conditions of 1 Hz and 30° C. The Young's modulus of the glass lens 2 is preferably 50 GPa or more, and the thickness is preferably 5 mm or more. With such a configuration, it is possible to obtain an optical unit enabling the deformation amount of the surface of the glass lens 2 caused by curing and shrinkage of the adhesive to be suppressed to 0.01 μm or less.

### Seventh Embodiment

A device according to a seventh embodiment of the present technology will be described.

The device according to the present embodiment includes the above optical unit. Examples of the device according to the present embodiment include an image pickup device, an image output device, and an optical device. Examples of the image pickup device include a camera, a personal digital assistant having a camera function, and a personal computer having a camera function. Examples of the image output device include a projector and a film projector. Examples of the optical device include an optical pickup device and an optical disk device including the optical pickup device.

The device including the above optical unit according to the present embodiment exhibits favorable optical performance since the distortion of the optical component is suppressed.

### EXAMPLES

Hereinbelow, the present technology will be described further in detail on the basis of examples. Note that the examples described below are representative examples of the present technology, and the scope of the present technology shall not be construed narrowly by these examples.

### Test Example 1

In Test Example 1, comparison experiments between examples and comparative examples were performed. FIG. 10 provides schematic views illustrating cross-sections of optical units in Examples 1 to 3 and Comparative Examples 1 and 2. FIG. 10A illustrates Example 1, FIG. 10B illustrates Example 2, FIG. 10C illustrates Comparative Example 1, FIG. 10D illustrates Example 3, and FIG. 10E illustrates Comparative Example 2. In each of FIGS. 10A to 10E, the upper figure illustrates the cross-section of the optical unit, and the lower figure illustrates the result of evaluation of the stress distribution after the adhesive is cured and shrunk.

Example 1 illustrated in FIG. 10A is an optical unit that includes the securing structure 1 for an optical component and the holding portion 3 described in the above first embodiment. That is, in Example 1, the securing structure for an optical component includes an optical component and an adhesive portion, the adhesive portion includes a first adhesive cured material layer and a second adhesive cured material layer, and the holding portion includes a holding frame and an adhesive groove.

Example 2 illustrated in FIG. 10B is an optical unit that includes the securing structure 21 for an optical component and the holding portion 3 described in the above third embodiment. Example 2 differs from Example 1 in that Example 2 includes a third adhesive cured material layer.

Comparative Example 1 illustrated in FIG. 10C is an optical unit that includes an optical component and a second adhesive cured material layer. Comparative Example 1 differs from Examples 1 and 2 in that Comparative Example 1 does not include the first adhesive cured material layer and the third adhesive cured material layer.

Example 3 illustrated in FIG. 10D is an optical unit that includes the securing structure 11 for an optical component and the holding portion 3 described in the above second embodiment. That is, in Example 3, the securing structure for an optical component includes an optical component and an adhesive portion, the adhesive portion includes a first adhesive cured material layer and a second adhesive cured material layer, and the holding portion includes a holding frame and does not include an adhesive groove.

Comparative Example 2 illustrated in FIG. 10E is an optical unit that includes an optical component and a second adhesive cured material layer. Comparative Example 2 differs from Example 3 in that Comparative Example 2 does not include the first adhesive cured material layer.

The optical component used in each of the examples and comparative examples is a glass circular-plate-like lens. The diameter of the optical component is 26.4 mm, and the thickness of the optical component is 1.4 mm. The width of the adhesive groove in each of Examples 1 and 2 and Comparative Example 1 is 2.8 mm, and the depth is 1.2 mm. The height of the adhesive portion (the distance between the lower surface of the optical component and the bottom surface of the adhesive groove) in each of Examples 1 and 2 and Comparative Example 1 is 1.2 mm, and the width of the adhesive portion (the length along the width direction of the adhesive groove) is 2.4 mm. The height of the adhesive portion in each of Example 3 and Comparative Example 2 is 1.4 mm, and the width of the adhesive portion (the distance between the outer peripheral surface of the optical component and the inner peripheral surface of the holding frame) is 1.8 mm.

The first adhesive cured material layer and the third adhesive cured material layer in each of the examples and comparative examples contains a cured material of modified silicone adhesive (SL220, manufactured by Konishi Co., Ltd.). The second adhesive cured material layer in each of the examples and comparative examples contains a cured material of modified acrylate adhesive (CML08, manufactured by Kyoritsu Chemical & Co., Ltd.).

The storage elastic modulus of each of the first adhesive cured material layer and the third adhesive cured material layer was 4.8 MPa, and the storage elastic modulus of the second adhesive cured material layer was 21 MPa in the dynamic mechanical analysis under the conditions of 1 Hz and 30° C. The storage elastic modulus was measured using a device in which a dynamic mechanical analysis (DMA) option (nanoDMAIII) was added to a nanoindentation device (Triboindenter TI980) manufactured by Hysitron.

The stress distribution and the distortion in the optical component after the adhesive was cured and shrunk were evaluated using Finite Element Method (FEM) software (ANSYS, manufactured by ANSYS).

In each of FIGS. 10A to 10E, the lower figure illustrates the stress distribution after the adhesive is cured and shrunk, and the more significant color change indicates the higher stress. As illustrated in FIGS. 10A to 10E, while high stress is generated in the optical components in Comparative Examples 1 and 2, the stress is relaxed in Examples 1 to 3. It was confirmed from these results that, due to the securing structure for an optical component according to the present technology, stress caused by curing and shrinkage of the adhesive was reduced.

The distortion (s) of the optical component after the adhesive was cured and shrunk was as follows. Note that the point at which the distortion was measured is indicated by a black circle in each of the lower figures in FIGS. 10A to 10E.

Example 1 (FIG. 10A): ε=1.0E-6

Example 2 (FIG. 10B): ε=0.52E-6

Comparative Example 1 (FIG. 10C): ε=4.72E-6

Example 3 (FIG. 10D): ε=0.92E-6

Comparative Example 2 (FIG. 10E): ε=2.08E-6

In this manner, in Examples 1 to 3, the distortion of the optical component was reduced further than in Comparative Examples 1 and 2. It was confirmed from these results that, due to the securing structure for an optical component according to the present technology, distortion of the optical component caused by curing and shrinkage of the adhesive could be reduced.

### Test Example 2

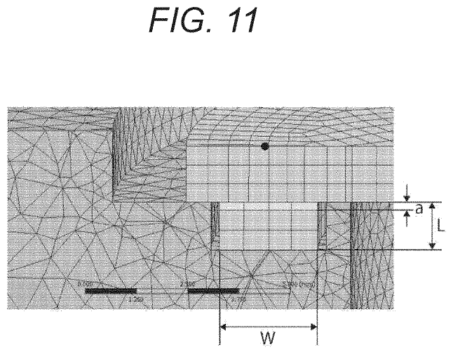

In Test Example 2, a test was performed to examine dependence of the distortion of the surface of the glass lens on the first adhesive cured material layer using the optical unit in Example 4. FIG. 11 is a schematic view illustrating a cross-section of the optical unit in Example 4. The optical unit in Example 4 has the configuration described in the above sixth embodiment and specifically includes a glass lens having a diameter of 30 mm, a thickness of 5 mm, and a Young's modulus of 50 GPa, a metallic holding portion, and an adhesive portion including the first adhesive cured material layer and the second adhesive cured material layer.

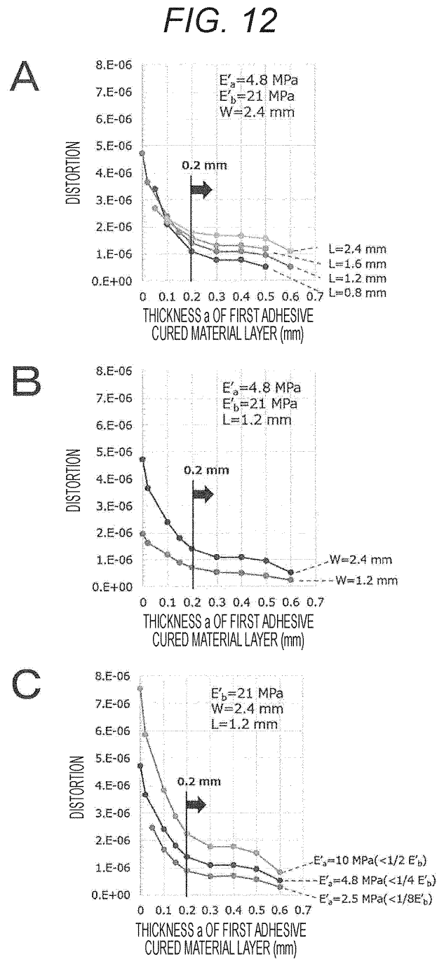

FIG. 12 provides graphs each illustrating the result of a viscoelasticity simulation using the optical unit in Example 4 illustrated in FIG. 11. The black circle in FIG. 11 indicates the point at which the distortion of the glass lens was analyzed. The viscoelasticity simulation was performed using Finite Element Method (FEM) software (ANSYS, manufactured by ANSYS).

The meanings of the characters illustrated in FIGS. 11 and 12 are as follows.

W=Width of adhesive portion (mm)

L=Height of adhesive portion (mm)

a=Thickness of first adhesive cured material layer (mm)

E′ₐ=Storage elastic modulus of first adhesive cured material layer (MPa)

E′_{b}=Storage elastic modulus of second adhesive cured material layer (MPa)

Also, in each of the graphs in FIG. 12, the vertical axis represents the distortion of the surface of the glass lens, and the horizontal axis represents the thickness a (mm) of the first adhesive cured material layer.

FIG. 12A illustrates the result in a case where the storage elastic modulus (E′ₐ) of the first adhesive cured material layer is 4.8 MPa, the storage elastic modulus (E′_{b}) of the second adhesive cured material layer is 21 MPa, the width (W) of the adhesive portion is 2.4 mm, and the height (L) of the adhesive portion is changed as a parameter. FIG. 12B illustrates the result in a case where the storage elastic modulus (E′ₐ) of the first adhesive cured material layer is 4.8 MPa, the storage elastic modulus (E′_{b}) of the second adhesive cured material layer is 21 MPa, the height (L) of the adhesive portion is 1.2 mm, and the width (W) of the adhesive portion is changed as a parameter.

As illustrated in FIGS. 12A and 12B, in a case where the thickness (a) of the first adhesive cured material layer is 0.0 to 0.2 mm, the distortion is reduced further as the thickness (a) increases further. However, in a case where the thickness (a) is 0.2 mm or more, the degree of the reduction in distortion becomes gentler, and it was confirmed that a substantially constant distortion suppressing effect was obtained with respect to the change in thickness (a). Also, in a case where the amount of the adhesive is increased by increasing the width (W) of the adhesive portion as illustrated in FIG. 12A or increasing the height (L) of the adhesive portion as illustrated in FIG. 12B, the distortion of the glass surface increases. However, even in a case where the amount of the adhesive increases, there is still the tendency of the degree of the reduction in distortion to be gentler in a case where the thickness (a) of the first adhesive cured material layer is 0.2 mm or more, and it was confirmed that a substantially constant distortion suppressing effect was obtained.

FIG. 12C illustrates the result in a case where the storage elastic modulus (E′_{b}) of the second adhesive cured material layer is 21 MPa, the width (W) of the adhesive portion is 2.4 mm, the height (L) of the adhesive portion is 1.2 mm, and the storage elastic modulus (E′ₐ) of the first adhesive cured material layer is changed as a parameter. As illustrated in FIG. 12C, it was confirmed that, even in a case where the storage elastic modulus (E′ₐ) was changed, a constant distortion suppressing effect was obtained in a case where the thickness (a) of the first adhesive cured material layer was 0.2 mm or more.

The result illustrated in FIG. 12 suggested that, in a case where the thickness of the first adhesive cured material layer was 0.2 mm or more under the conditions in which the diameter of the glass lens was 25 mm or more, and in which each of the width and the height of the adhesive portion was 1/10 or less of the diameter of the glass lens, the stress relaxation effect did not significantly fluctuate even in a case where the thickness slightly varied, and a substantially constant stress relaxation effect was obtained.

### Test Example 3

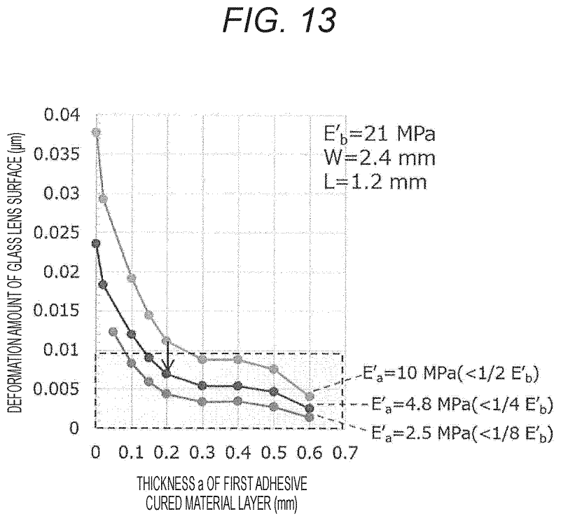

In Test Example 3, a test was performed to examine dependence of the deformation amount of the surface of the glass lens on the first adhesive cured material layer using the optical unit in Example 4. FIG. 13 is a graph illustrating the result of a viscoelasticity simulation in a similar method to that in Test Example 2 using the optical unit in Example 4 illustrated in FIG. 11. Specifically, FIG. 13 illustrates the result in a case where the storage elastic modulus (E′_{b}) of the second adhesive cured material layer is 21 MPa, the width (W) of the adhesive portion is 2.4 mm, the height (L) of the adhesive portion is 1.2 mm, and the storage elastic modulus (E′ₐ) of the first adhesive cured material layer is changed as a parameter. In the graph in FIG. 13, the vertical axis represents the deformation amount (μm) of the surface of the glass lens, and the horizontal axis represents the thickness a (mm) of the first adhesive cured material layer.

It was confirmed from the result in FIG. 13 that, in a case where the thickness (a) of the first adhesive cured material layer was 0.2 mm or more, in which case, a substantially constant distortion suppressing effect was obtained, and where the storage elastic modulus (E′ₐ) was low, the deformation amount of the surface of the glass lens was further reduced. It was also confirmed that, in a case where the thickness (a) of the first adhesive cured material layer was 0.2 mm or more, by setting the storage elastic modulus (E′ₐ) of the first adhesive cured material layer to 4.8 MPa or less (¼ or less of the storage elastic modulus (E′_{b}) of the second adhesive cured material layer), an optical unit with a deformation amount of 0.01 μm or less on the surface of the glass lens could be achieved.

Meanwhile, in a case where the Young's modulus of the glass lens is 50 GPa or more, and where the thickness is 5 mm or more, the distortion and the deformation amount of the surface of the glass lens are smaller than those in Example 4, which suggested that, by setting the thickness (a) of the first adhesive cured material layer to 0.2 mm or more, the unevenness of the surface of the glass lens could be suppressed to 0.01 μm or less.

Note that the present technology can employ the following configuration.
[1] A securing structure for an optical component, including an optical component, and an adhesive portion that is in contact with a holding portion for the optical component,

in which the adhesive portion includes a first adhesive cured material layer and a second adhesive cured material layer,

the first adhesive cured material layer is located between the optical component and the second adhesive cured material layer, and

a storage elastic modulus of the first adhesive cured material layer is lower than a storage elastic modulus of the second adhesive cured material layer.
[2] The securing structure for an optical component according to [1], in which the storage elastic modulus of the first adhesive cured material layer is ½ or less of the storage elastic modulus of the second adhesive cured material layer.
[3] The securing structure for an optical component according to [1] or [2], in which the storage elastic modulus of the second adhesive cured material layer is 10 MPa or more in a dynamic mechanical analysis under conditions of 1 Hz and 30° C.
[4] The securing structure for an optical component according to any one of [1] to [3], in which the first adhesive cured material layer contains a cured material of silicone adhesive, a cured material of modified silicone adhesive, or a cured material of urethane adhesive.
[5] The securing structure for an optical component according to any one of [1] to [4], further including a third adhesive cured material layer,

in which the third adhesive cured material layer is arranged at a position opposed to the first adhesive cured material layer with the second adhesive cured material layer interposed therebetween, and

a storage elastic modulus of the third adhesive cured material layer is lower than the storage elastic modulus of the second adhesive cured material layer.
[6] An optical unit including the securing structure for an optical component according to any one of [1] to [5], and the holding portion that holds the optical component.
[7] A device including the optical unit according to [6].
[8] An optical unit including the securing structure for an optical component according to any one of [1] to [4], and a metallic holding portion that holds the optical component,

in which the optical component is a glass lens,

in a case where a diameter of the glass lens is 25 mm or more, each of a width and a height of the adhesive portion is 1/10 or less of the diameter of the glass lens, and

in a case where the diameter of the glass lens is less than 25 mm, each of the width and the height of the adhesive portion is 2.5 mm or less.
[9] The optical unit according to [8], in which a thickness of the first adhesive cured material layer is 0.2 mm or more.
[10] The optical unit according to [9],

in which the glass lens has a Young's modulus of 50 GPa or more and a thickness of 5 mm or more,

the storage elastic modulus of the first adhesive cured material layer is ¼ or less of the storage elastic modulus of the second adhesive cured material layer, and

the storage elastic modulus of the second adhesive cured material layer is 21 MPa or less in the dynamic mechanical analysis under conditions of 1 Hz and 30° C.

### REFERENCE SIGNS LIST

1, 11, 21, 31 Securing structure for an optical component
2 Optical component
3 Holding portion
3a Holding frame
3b Bottom surface portion
3c Adhesive groove
3d Through hole
4 Adhesive portion
4a, 14a, 24a, 34a First adhesive cured material layer
4b, 14b, 24b, 34b Second adhesive cured material layer
24c, 34c Third adhesive cured material layer

1. A securing structure for an optical component, comprising: an optical component; and an adhesive portion that is in contact with a holding portion for the optical component,
wherein the adhesive portion includes a first adhesive cured material layer and a second adhesive cured material layer,
the first adhesive cured material layer is located between the optical component and the second adhesive cured material layer, and
a storage elastic modulus of the first adhesive cured material layer is lower than a storage elastic modulus of the second adhesive cured material layer.

2. The securing structure for an optical component according to claim 1, wherein the storage elastic modulus of the first adhesive cured material layer is ½ or less of the storage elastic modulus of the second adhesive cured material layer.

3. The securing structure for an optical component according to claim 1, wherein the storage elastic modulus of the second adhesive cured material layer is 10 MPa or more in a dynamic mechanical analysis under conditions of 1 Hz and 30° C.

4. The securing structure for an optical component according to claim 1, wherein the first adhesive cured material layer contains a cured material of silicone adhesive, a cured material of modified silicone adhesive, or a cured material of urethane adhesive.

5. The securing structure for an optical component according to claim 1, further comprising: a third adhesive cured material layer,
wherein the third adhesive cured material layer is arranged at a position opposed to the first adhesive cured material layer with the second adhesive cured material layer interposed therebetween, and
a storage elastic modulus of the third adhesive cured material layer is lower than the storage elastic modulus of the second adhesive cured material layer.

6. An optical unit comprising: the securing structure for an optical component according to claim 1; and the holding portion that holds the optical component.

7. A device comprising: the optical unit according to claim 6.

8. An optical unit comprising: the securing structure for an optical component according to claim 1; and a metallic holding portion that holds the optical component,
wherein the optical component is a glass lens,
in a case where a diameter of the glass lens is 25 mm or more, each of a width and a height of the adhesive portion is 1/10 or less of the diameter of the glass lens, and
in a case where the diameter of the glass lens is less than 25 mm, each of the width and the height of the adhesive portion is 2.5 mm or less.

9. The optical unit according to claim 8, wherein a thickness of the first adhesive cured material layer is 0.2 mm or more.

10. The optical unit according to claim 9,
wherein the glass lens has a Young's modulus of 50 GPa or more and a thickness of 5 mm or more,
the storage elastic modulus of the first adhesive cured material layer is ¼ or less of the storage elastic modulus of the second adhesive cured material layer, and
the storage elastic modulus of the second adhesive cured material layer is 21 MPa or less in the dynamic mechanical analysis under conditions of 1 Hz and 30° C.
